(19) United States
(12) Patent Application Publication
(10) Pub. No.: US 2005/0155275 A1
(43) Pub. Date: Jul. 21, 2005

(54) Fishing line receptacle

(76) Inventor: Chris Keksi, Bend, OR (US)

Correspondence Address: IPSOLON LLP, 805 SW BROADWAY, #2740, PORTLAND, OR, 97205, US

(21) Appl. No.: 10/783,439

(22) Filed: Feb. 19, 2004

Related U.S. Application Data
(60) Provisional application No. 60/538,071, filed on Jan. 20, 2004.

(51) Int. Cl. A01K 97/06

(52) U.S. Cl. 43/54.1

(57) ABSTRACT

An apparatus for use by fishermen defines a receptacle having a closed end and an open end covered with a membrane through which spent fishing line may be inserted. The spent line is received into the receptacle and is held in the receptacle by the membrane. The line is removed later for recycling or disposal in an appropriate manner.

### FIELD OF THE INVENTION

This invention relates generally to the field of fishing and more particularly to an apparatus worn by fishermen for containing fishing line that otherwise might be discarded into a waterway.

### BACKGROUND

There are many different types of fishing line used throughout the world, and nearly all fishermen, regardless of what type of fishing they are doing, use fishing line. Often, substantial quantities of fishing line are expended while fishing. For example, small pieces of line are commonly cut off while tying hooks and other tackle. Longer segments of line are just as often rendered useless for a variety of reasons, such as tangles and knots. The most common type of fishing line is probably the ubiquitous type of line called monofilament. Monofilament line is thin, strong, and some types are nearly invisible to fish and other wildlife. These qualities make monofilament line excellent for use in all types of angling. But monofilament line also degrades very slowly in the environment, and some information indicates that monofilament line may remain in the environment for hundreds of years.

Unfortunately, fishermen often discard their used or otherwise spent line into the environment, which may result in numerous environmental problems. Considering its environmental longevity and the fact that it is often nearly invisible in the environment, discarded monofilament line can pose a serious risk to numerous types of wildlife. Birds, mammals, reptiles and fish often are unable to see improperly discarded monofilament line in the water and near waterways and as a result, may become entangled. Such encounters often lead to injury, disfigurement, drowning, strangulation and starving.

The problems caused by discarded fishing line are not limited to wildlife; humans and their equipment are nearly just as often adversely effected. For example, fishing line fowls boat propellers, bilge pumps, and water intake valves, it can interfere with swimmers, and it can be a hazard to scuba divers.

Given these known and serious concerns about improperly discarded of fishing line, particularly plastic monofilament line, numerous recycling programs are being started up around the United States and in other parts of the world. While there are many types of monofilament line, most are primarily composed of single strand, high density plastic or nylon compounds that can be recycled by melting and reused in other products. Monofilament recycling programs are designed to educate fishermen about the serious nature of the problems arising from waste fishing line, and to encourage proper disposal of spent line. As part of these programs, recycling collection containers are being installed near boat launching ramps, near or on docks, marinas and fishing piers, and other locations where fishermen are likely to pass by. Even if fishing line collected in such containers is not readily recycled, at the very least it may be disposed of properly, alleviating many environmental problems and reducing the risks to wildlife.

Many of these education and recycling programs are beginning to show successful results. However, much more needs to be done, and present programs do not address the problems encountered by fisherman of discarding fishing line where it is being used: by the fisherman in a boat, or in a waterway (for example, wading in a stream or lake, floating in float tube in a lake, etc.). Known recycling containers are typically mounted to a post near a fishing location—remote from the place where the fishing is actually done.

There is a need therefore for apparatus that provides a fisherman with a means of disposing of fishing line while he or she is fishing.

### SUMMARY OF THE INVENTION

The present invention is an apparatus for use by fishermen and defines a receptacle having a closed end and an open end covered with a membrane having an opening therethrough, through which spent fishing line may be inserted. The spent line is received into the receptacle and is held in the receptacle by the membrane. The receptacle may be opened and the line is removed for recycling or disposal in an appropriate manner.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of one illustrated embodiment of a receptacle according to the present invention, showing a segment of fishing line being inserted into the receptacle.

FIG. 2 is a partially exploded longitudinal cross sectional view of the embodiment of the receptacle shown in FIG. 1.

FIG. 3 is a top plan view of the embodiment illustrated in FIG. 1, showing the slotted membrane that covers one end of the receptacle.

FIG. 4 is an exploded perspective view of the receptacle shown in FIG. 1, illustrating the components of the receptacle.

### DETAILED DESCRIPTION OF THE PREFERRED EMBODIMENTS

The receptacle according to the illustrated invention defines an easily used container for recycling spent fishing line. The receptacle is preferably small, light and easily carried by a fisherman or attached to the belt or vest. The receptacle includes means for retaining spent line in the interior of the container and for easily emptying the contents.

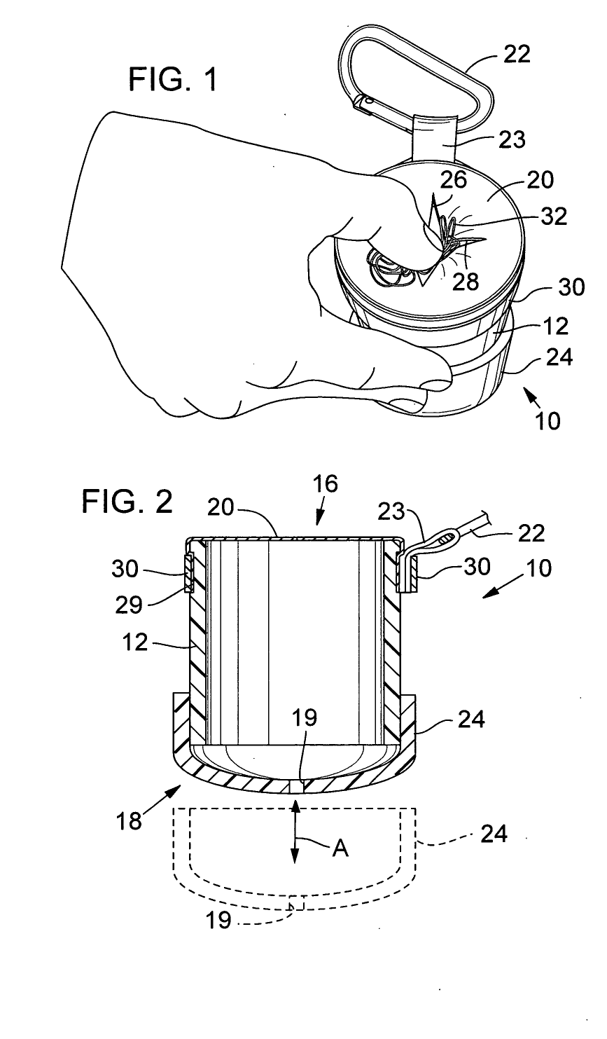

With reference to the drawings, an illustration of a preferred embodiment of a receptacle 10 according to the present invention is shown in FIG. 1. As detailed below, receptacle 10 may take many forms in addition to the generally cylindrical, tubular form of the embodiment illustrated herein. Nonetheless, the embodiment shown in the drawings with a tubular main body describes one preferred embodiment of the invention.

Turning momentarily to FIG. 2, receptacle 10 includes a main body section 12, which in the illustrations is shown as a hollow cylinder, but which could be virtually any shape such as square, etc. With reference to FIG. 4, main body 12 is hollow and defines an open interior space 14 that is capable of holding fishing line. Receptacle 10 further comprises a first end 16 and an opposite second end 18. As detailed below, first end 16 is covered with a slotted membrane 20 to allow access into interior space 14, and second end 18 is closed with a covering that is readily removable. Receptacle 10 further includes a clip 22 that is shown as a standard carabiner connected to a lanyard 23, but which could be any type of clip that allows the receptacle to be quickly attached to a fisherman's belt, fishing vest, or to the boat and the like.

Receptacle 10 is shown in a partially exploded view in FIG. 2 in which it may be seen that second end 18 is defined by a cap 24 that is removably attachable to main body 12. In the illustrated embodiment, cap 24 is a cylindrical cap that has an interior diameter that is slightly larger than the exterior diameter of main body 12. Accordingly, cap 24 is easily slid onto main body 12 to close second end 18, and is just as easily slid off main body 12 to allow access to interior space 14, as illustrated by arrow A. Where a removable cap 24 is used with receptacle 10, it may be made removable in any convenient manner, such as being threaded onto the main body 12, or hinged thereto, etc. As shown in FIG. 2, a relatively small through hole 19 may be drilled in the central portion of cap 24 to allow water to drain out of the receptacle.

The opening through which spent fishing line is inserted into interior space 14 is located at first end 16. First end 16 defines an opening into interior space 14 by means of intersecting slots 26 and 28 formed through membrane 20, which covers the entire first end 16. Membrane 20 is preferably fabricated from a flexible, resilient material that defines a septum such as rubber or latex. The membrane is attached to the main body 12 with a connecting clamp 30 or other appropriate connector. As shown in FIG. 4, it is advantageous to form a circumferential annular slot 29 in main body 12 near first end 16 that forms a seat extending around the outer periphery of the main body. When the membrane 20 is attached to main body 12 with connecting clamp 30 as shown in FIG. 2, the clamp binds membrane 20 in the slot 29 to prevent unintended removal of the membrane. When using this manner of connecting membrane 20 to main body 12, the circumferential size of membrane 20 is larger than the circumference of main body 12, which is shown with dashed line 25 in FIG. 4. This allows the outer peripheral portions of membrane 20—that is, those portions of the membrane outward of dashed line 25, to be captured with clamp 30. In the embodiment illustrated in the figures, lanyard 23 is also captured and bound by clamp 30.

Preferably, clamp 30 is removable so that membrane 20 is also removable so that it may be replaced over time as the membrane becomes less flexible from exposure to sunlight, etc.

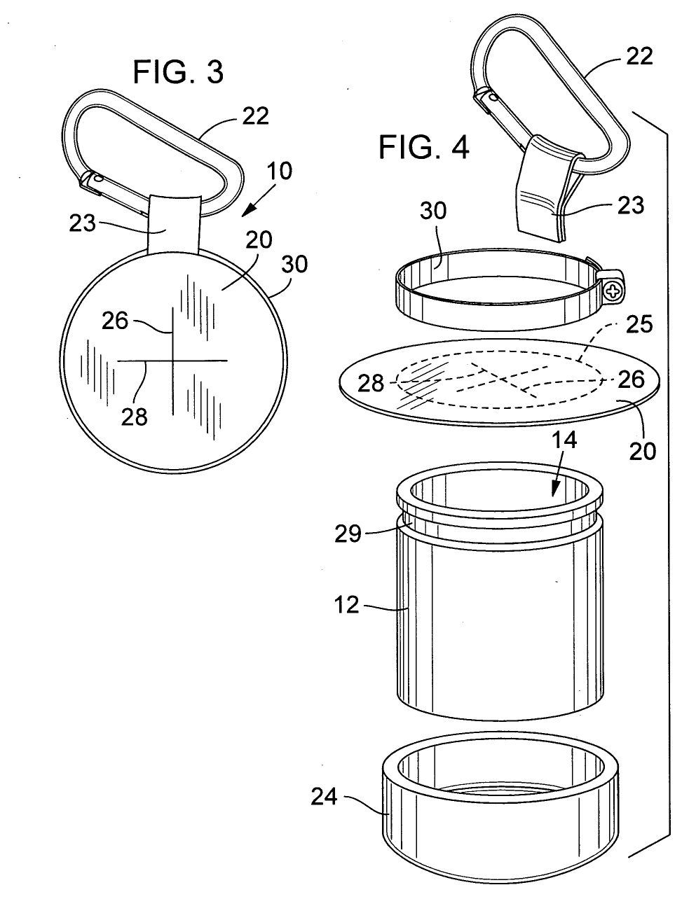

With continuing reference to FIGS. 2 and 3, intersecting slots 26 and 28 are cut through membrane 20 in the form of an X and define the opening into interior space 14. Because the material used to form membrane 20 is flexible and deformable, the opening defined by slots 26 and 28 is normally closed, as shown in FIGS. 3 and 4.

The opening defined by X slots 26 and 28 allow a fisherman to push fishing line through the slots into interior space 14. This is illustrated in FIG. 1, which shows a segment of fishing line 32 being inserted through slots 26, 28 and into interior 14. Because membrane 20 is resilient, the membrane 20 and slots 26, 28, deform and open when pressure is applied to the flexible membrane near the slots to thereby allow fishing line 32 to be pushed through the opening and into the interior space. For the same reason, the slots 26, 28 tend to close around the fishing line 32 and the fisherman's finger or fingers as the line is pushed through the slots into the interior 14 of the receptacle. Thus, the apexes defined by slots 26, 28 tend to deflect inwardly toward interior space 14 when fishing line 32 is pushed through the slots. As the fisherman pulls his or her finger or fingers out of the slots, the resilient membrane 20 flexes and the apexes of the slots 26, 28 deflect upwardly toward or beyond the resting or neutral position, yet all the while exerting pressure in an inward direction (toward the center of the X defined by slots 26, 28) onto the fishing line 32 and the fisherman's finger(s). This inwardly directed pressure causes the fishing line to be retained in interior space 14, and tends to “wipe” the line away from the fisherman's fingers. When the fisherman thus pulls his or her fingers out of the slots 26, 28, fishing line that has been pushed into receptacle 10 stays in the interior space 14.

As noted previously, clip 22 allows receptacle 10 to be quickly attached to and removed from the fisherman's belt, or fishing vest and the like, or to a convenient location on a float tube or in a boat. The clip 22 may be attached to receptacle 10 in any convenient manner and location—the clip 22 and lanyard 23 shown in the drawings is for illustrative purposes only. Furthermore, receptacle 10 is designed to be used in close proximity to the fisherman—that is, either worn on the belt or vest, or clipped to some other nearby object such as a boat or a float tube and the like.

In use, the receptacle is assembled as shown in FIG. 1 and the receptacle is attached to a belt or fishing vest and the like, or is stowed in a tackle box or in a boat. Fishing line 32 is pushed into the interior space 14 in the manner described above through slots 26, 28 in membrane 20 that covers first end 16. The line accumulates in interior space 14 until the fisherman is ready to empty the contents into a recycling container or into an appropriate disposal container. The receptacle is emptied by removing cap 24, which allows the entire contents to be removed from interior space 14 quickly. Cap 24 is then replaced as shown in FIG. 1.

Because membrane 20 is flexible, it allows a fisherman to insert fishing line 32 through the slots 26, 28 even when his or her hands are wet and/or very cold and dexterity might thus be impaired.

Various alternative embodiments may be made within the scope of the invention defined by the claims. For example, the second end 18 of receptacle 10 may be permanently closed and the first end 16 may be defined by a removable membrane 20 that is attachable to main body 12 in the same manner as cap 24 described above, or any other convenient manner such as a threaded cap. Cap 24 may further be threaded onto main body 12. As another example of alternative structures, the slots 26, 28 described above may be replaced by any type of opening in the membrane that allows fishing line to be pushed into the interior space 14, such as a hinged, valve-like plate, or a circular opening and the like.

While the present invention has been described in terms of a preferred embodiment, it will be appreciated by one of ordinary skill that the spirit and scope of the invention is not limited to those embodiments, but extend to the various modifications and equivalents as defined in the appended claims.

1. A fishing line receptacle comprising:
a main body defining an interior space, said main body having a first closed end and a second end;
a flexible membrane covering the second end, the flexible membrane having an opening therethrough to define an opening into the interior space.

2. The fishing line receptacle according to claim 1 wherein the opening through the flexible membrane further comprises intersecting slots cut through said membrane.

3. The fishing line receptacle according to claim 3 wherein said intersecting slots define an X shaped opening into the interior space.

4. The fishing line receptacle according to claim 1 wherein said first closed end of said main body is defined by a removable cap.

5. The fishing line receptacle according to claim 4 wherein said opening into the interior space is normally closed and said flexible membrane is deformable to allow the opening to be opened so that fishing line may be inserted through said opening into said interior space.

6. The fishing line receptacle according to claim 1 wherein said flexible membrane is removably attached to said second end.

7. The fishing line receptacle according to claim 1 wherein said main body includes an annular groove extending around an exterior surface of said main body and wherein said flexible membrane is attached to said main body with a clamp that binds said flexible membrane in said groove.

8. The fishing line receptacle according to claim 1 including a selectively openable clip.

9. The fishing line receptacle according to claim 8 wherein said clip is attached to said main body.

10. The fishing line receptacle according to claim 1 wherein the opening through the flexible membrane further comprises intersecting slots cut through said membrane to define an X shaped opening into said interior space that is normally closed but which is deformable by applying pressure on said slots to thereby allow the opening to be opened so that fishing line may be inserted through said opening into said interior space.

11. A receptacle for receiving spent fishing line, comprising:
main body means for receiving and retaining spent fishing line;
septum means for defining a selectively openable opening into said main body means.

12. The receptacle according to claim 11 wherein said main body means is further defined by a body having an interior space and one closed end, and wherein said septum means is attached to said main body at an opposite end.

13. The receptacle according to claim 12 wherein said septum means comprises a flexible member having a pair of intersecting slots formed therethrough to define said opening, and wherein said opening is normally closed.

14. The receptacle according to claim 13 wherein said flexible member is removably attached to said main body.

15. The receptacle according to claim 14 wherein said closed end of said main body is defined by a removable cap means for allowing said closed end to be selectively opened and closed.

16. The receptacle according to claim 11 including clip means for removably attaching said receptacle to an object.

17. A portable container for use in recycling used fishing line, comprising:
a hollow main body having one open end and one closed end to define an interior space therebetween, the open end defined by a flexible member having a normally closed opening therethrough, said normally closed opening being openable by deforming said flexible member.

18. The portable container according to claim 17 wherein said closed end is defined by a removable cap.

19. The portable container according to claim 18 wherein said normally closed opening through said flexible membrane comprises a pair of intersecting slots through said membrane.

20. The portable container according to claim 19 including a drain hole formed in said removable cap.
